(19) United States
(12) Patent Application Publication
(10) Pub. No.: US 2002/0188506 A1
(43) Pub. Date: Dec. 12, 2002

(54) Method and apparatus for providing a pay-at-delivery interface to a driver of a vehichle

(75) Inventor: Gordon James Smith, Rochester, MN (US)

Correspondence Address: Gero G. McClellan, Thomason, Moser & Patterson, L.L.P., Suite 1500, 3040 Post Oak Boulevard,, Houston, TX, 77056-6582, US

(73) Assignee: International Business Machines Corporation, Armonk, NY (US)

(21) Appl. No.: 09/877,392

(22) Filed: Jun. 8, 2001

(51) Int. Cl. G06F 17/60

(52) U.S. Cl. 705/14

(57) ABSTRACT

Method and apparatus for providing an interface to a driver of a vehicle. In one embodiment, a vehicle identifier is initially received from the vehicle via a wireless network. In some embodiments, the vehicle identifier may be used to identify the driver of the vehicle. Information, such as driving information and/or consumer information, is provided on a display of a pay at delivery system (PADS). Alternatively or additionally, the information may be transmitted to the vehicle for display to the driver. The information may be tailored using driver profile information, environmental information and the like.

### BACKGROUND OF THE INVENTION

1. Field of the Invention

The invention relates to computer systems. More particularly, the invention relates to a method and apparatus for providing an interface to a driver of a vehicle.

2. Background of the Related Art

Vehicle service centers, such as gas stations, generally sell gasoline to drivers of vehicles. To automate the sale of gasoline, many vehicle service centers use a conventional pay at delivery system (PADS) in a gas pump. Using PADS, a driver or customer receives gasoline and then uses a credit card to pay for the gasoline at the PADS. The PADS enables the customer to purchase gasoline without the need of taking additional time to pay a gas station attendant. For example, the customer may avoid the inconvenience of entering a nearby building to pay an attendant or possibly waiting for other people to complete their purchases.

However, with the conventional PADS, the communication between the driver and the service center is very limited. The conventional PADS is generally limited to gasoline purchases at the gas pump. Namely, the PADS does not involve other aspects of the service center that may also operate as a convenience store and/or vehicle repair center. Additionally, the conventional PADS does not interact with the driver prior to the vehicle entering the service center. There is no prior communication with the driver via the vehicle.

Thus, a need exists in the art to enhance the communication between the driver and the service center.

### SUMMARY OF THE INVENTION

The invention provides a method and apparatus for providing an interface to a driver of a vehicle. In one embodiment, a vehicle identifier is initially received from the vehicle via a wireless network. The vehicle identifier is used to identify the driver of the vehicle. Driving information and/or consumer information is provided on a display of a pay at delivery system (PADS).

Another embodiment provides a method of providing an interface to a driver of a vehicle. The method comprises obtaining a current location of the vehicle via a wireless network; determining whether a destination location of the vehicle is obtainable; retrieving, if the destination of the vehicle is obtained, at least one route from the current location to the destination location; retrieving, for each route retrieved, at least one of traffic information, emergency information and weather information; and providing the retrieved traffic information, emergency information and weather information on a display at a pay-at-delivery system (PADS).

An apparatus for providing an interface to a driver of a vehicle is also provided. In one embodiment, the apparatus comprises a memory, a network interface, a wireless device, a display device and a processor. The memory stores a pay at delivery system (PADS) interface program. The network interface is configured for communicating with a database. The wireless device receives a vehicle identifier from the vehicle. The vehicle identifier may be received, for example, when the vehicle is within a predetermined distance from the wireless device. The display device displays at least one of driving information and consumer information. The processor, upon executing the PADS interface program, is configured to provide at least one of the driving information and the consumer information to the display device.

### BRIEF DESCRIPTION OF THE DRAWINGS

The teachings of the present invention can be readily understood by considering the following detailed description in conjunction with the accompanying drawings, in which:

FIG. 1 depicts a system for providing an interface to a vehicle;

FIG. 2 depicts a block diagram of a pay at delivery station (PADS) in the system of FIG. 1;

FIGS. 3A and 3B collectively depict a flow diagram of a method for implementing the PADS;

FIG. 4 depicts a flow diagram of a method for providing reminders to the vehicle;

FIG. 5 depicts a flow diagram of a method for providing the fuel efficiency of the vehicle;

FIG. 6 depicts a flow diagram of a method for providing available travel routes for the vehicle;

FIGS. 7A and 7B collectively depict a flow diagram of a method for providing advertisements for the vehicle;

FIGS. 8A and 8B collectively depict a flow diagram of a method for providing discounts; and

FIG. 9 depicts a flow diagram of a method for providing an electronic mail message to the vehicle.

To facilitate understanding, identical reference numerals have been used, where possible, to designate identical elements that are common to the figures.

### DETAILED DESCRIPTION OF THE PREFERRED EMBODIMENT

A method and apparatus for providing an interface to a driver of a vehicle. In one embodiment, a vehicle identifier is initially received from the vehicle via a wireless network. The vehicle identifier is used to identify the driver of the vehicle. Driving information and/or consumer information is provided on a display of a pay at delivery system (PADS).

Various programs and devices described hereinafter may be identified based upon the application for which they are implemented in a specific embodiment of the invention. However, it should be appreciated that any particular program or device nomenclature that follows is used merely for convenience, and the invention is not limited to use solely in any specific application identified and/or implied by such nomenclature.

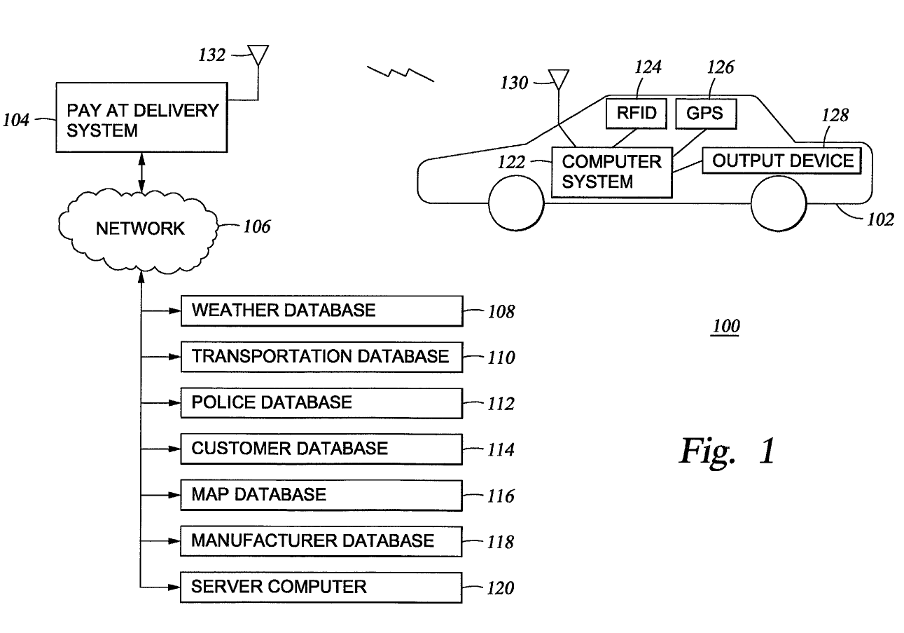

FIG. 1 depicts a system 100 for providing an interface to a driver of a vehicle 102. The system 100 comprises the vehicle 102 and a pay at delivery system (PADS) 104. The vehicle 102 is an automobile or other type of mobile vehicle that is capable of communicating with the PADS 104 via wireless means, e.g., a wireless network. In one embodiment, the vehicle 102 contains a display system 122, a RFID (radio frequency identification) device 124, a GPS (global positioning system) device and an output device 128.

The display system 122 comprises a computer system that is configured to provide a display on the output device 128. The RFID device 124 may comprise a RFID transponder that provides a unique RFID code in response to a broadcast signal from the PADS 104. The GPS device 126 identifies the current location of the vehicle 102. The output device 128 displays the interface to the driver. In one embodiment, the interface is provided from a signal transmitted from the PADS 104 via the wireless network. An antenna 130 enables the vehicle 102 to communicate, e.g., receive and transmits signals, with the PADS 104.

The PADS 104 provides an interface to a driver of the vehicle 102. The “interface” represents a display that is viewable by the driver of the vehicle 102. In one embodiment, the interface is provided on a display of the PADS 104. A driver may then view the interface when at the PADS, e.g., the fueling the vehicle 102 at a service station or paying for a purchase at the PADS 104. In another embodiment, the interface is provided in the vehicle 102 while the vehicle 102 is moving or mobile. Possible locations of the interface in the vehicle 102 may include a dashboard, a front window, behind a steering wheel, or any other location in the vehicle 102 viewable by the driver 102. In one embodiment, the interface is a Heads Up Display (HUD) projected onto a surface, e.g., the front window of the vehicle 102.

To provide the information for the interface, the PADS 104 initially communicates with the vehicle 102. In one embodiment, the PADS 104 broadcasts a signal over an antenna 132 via the wireless network. The RFID transponder 124 in the vehicle 102 receives the signal and transmits a signal containing the unique RFID code of the vehicle 102. The vehicle 102 is considered as detected when the PADS 104 detects the RFID identifier transmitted from the vehicle 102. Alternatively, communication between the vehicle 102 and the PADS 104 may be initiated by the RFID transponder 124. For example, the RFID transponder 124 may emit a constant or periodic signal. Upon detection by the PADS 104, the PADS 104 returns a confirmation signal. The PADS 104 may also obtain the location of the vehicle 102 from the GPS device 126 and other information, e.g., a user provided destination and available amount of gasoline consumed, from the computer system 122.

Once the vehicle 102 is detected, the PADS 104 may provide the interface to the driver of the vehicle 102. In one embodiment, the interface is dependent upon different types of information including the weather, the traffic and the presence of emergency situations in an area, e.g., a town or city, or roads near the vehicle 102. The PADS 104 obtains such information by sending a query or a request to various databases and server computers 108-120. These databases and computers 108-120 then provide the queried or requested information in response to the query or request. Specifically, the PADS 104 may obtain information via a network 106 from a weather database 108, a transportation database 110, a police database 112, a customer database 114, a map database 116, and a manufacturer database 118. The PADS 104 may also obtain information via the network 106 from server computers 120.

In one embodiment, the PADS 104 may provide an interface pertaining to different types of driving information to the driver of the vehicle 102. For example, the PADS 104 may provide reminders for service of the detected vehicle 102, provide the fuel efficiency of the vehicle 102, and determine travel routes for the vehicle 102. In other embodiment, the PADS 104 may provide consumer information to the driver of the vehicle 102. One type of consumer information is advertising information. For example, the PADS 104 may provide advertisements to the driver of the vehicle 102, provide discounts to future purchases, apply discounts to current purchases, and provide electronic mail messages with information and advertisements.

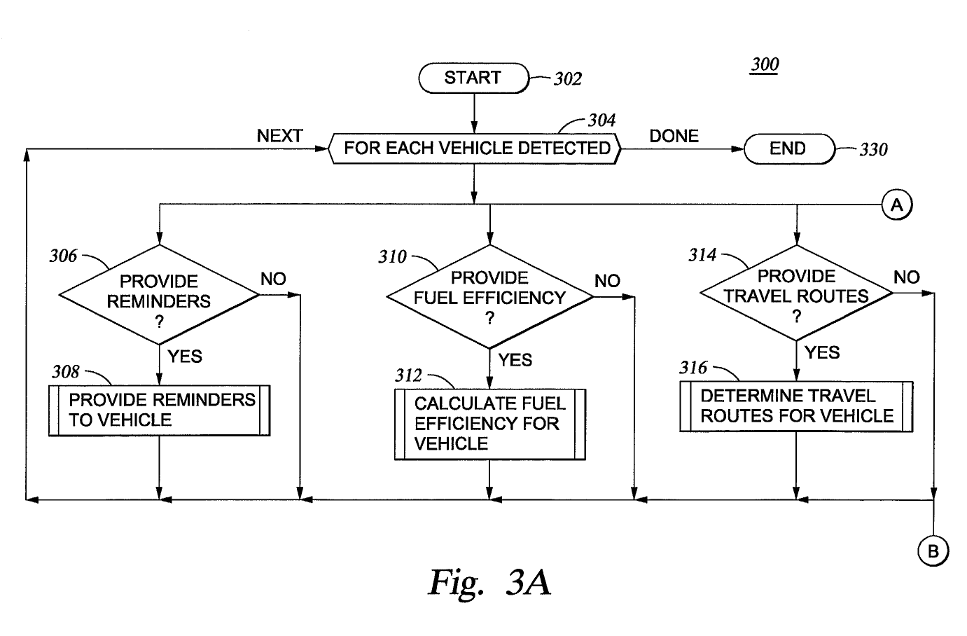

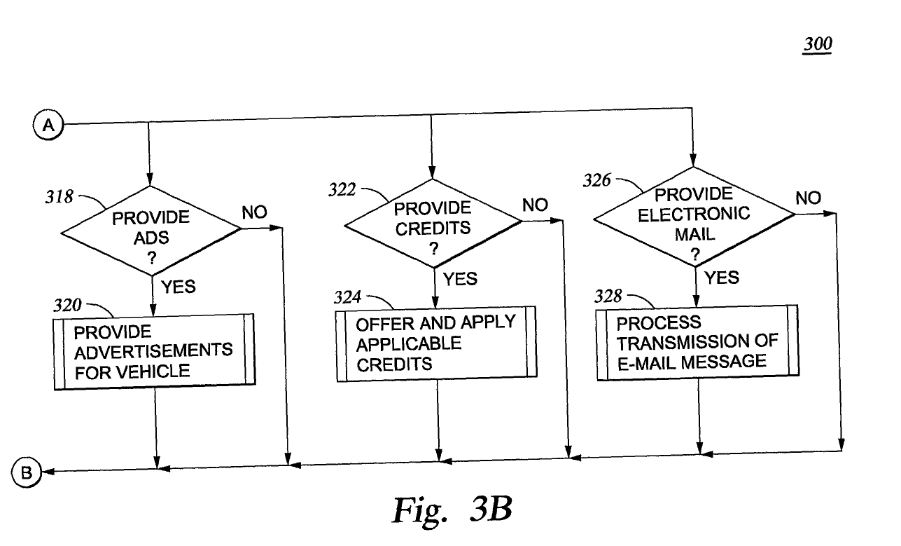

The PADS 104 is capable of providing any or all of these embodiments of the interface. An operator of the PADS 104 may enable one or more of these interfaces. As such, the exact combination of these interfaces provided depends on the operator of the PADS 104. However, the PADS 104 is not limited to the embodiments described above. Namely, an operator the PADS 104 may configure the interface to include other features involving driving information and consumer information. Embodiments of the interface are further described with respect to FIGS. 3-9.

The network 106 is used to transmit signals between the PADS 104 and the various databases and server computers 108-120. In one embodiment, the network 106 may comprise a collection of networks known as the Internet. Individual networks within the Internet may comprise a point to point network, e.g., a plain old telephone system (POTS) network, a broadcast network, e.g., a wireless or RF network, and the like. Transmission of video and control signals through the network 106 is performed in accordance with standard transmission formats, e.g., TCP/IP (Transmission Control Protocol / Internet Protocol), ATM (Asynchronous Transfer Mode), SONET (Synchronous Optical Network) and the like.

The weather database 108 provides weather information, e.g., a forecast, for a requested area or region. The transportation database 110 provides traffic information along routes for a requested area or region. The police database 112 provides emergency information for a requested area or region. The customer database 114 provides customer information for the driver of an identified vehicle 102, e.g., a vehicle 102 having a unique RFID. The map database 116 provides a listing of available routes for given start and destination locations. The manufacturer database 118 provides information for a given type or model of the vehicle 102. The server computers 120 provide information not provided from the other databases 110-118.

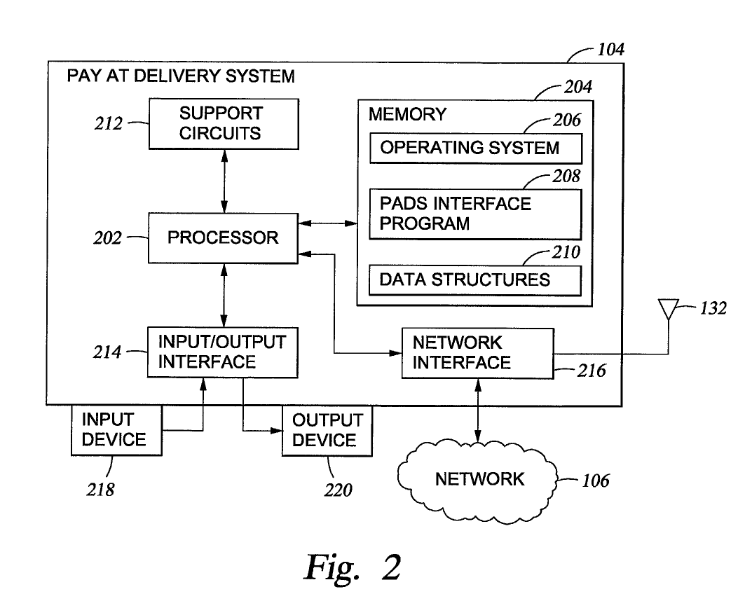

FIG. 2 depicts a block diagram of the pay at delivery system (PADS) 104 in the system 100 of FIG. 1. The PADS 104 provides the interface to a driver of the vehicle 102. The interface may be provided in the vehicle 102 or on the PADS 104. To provide the interface, the PADS 104 communicates with the vehicle 102 and communicates with various databases and server computers 108120 via the network 106. In one embodiment, the PADS 104 comprises a processor 202, a memory 204, support circuits 212, an input/output interface 214 and a network interface 216.

The processor 202 performs instructions based upon the requirements of the operating system 206 and the PADS interface program 208 stored in the memory 204. The processor 202 executes the PADS interface program 208 to operate the PADS 104. In one embodiment, the processor 202 is configured to initiate a broadcast of a signal via the network interface 216, e.g., a transceiver, and the antenna 132 to a wireless network. The vehicle 102 receives the broadcast signal and transmits a unique RFID code back to the wireless network. The processor 202 is also configured to receive the RFID code and GPS information from the vehicle 102 via the antenna 132 and network interface 216. The RFID code identifies the vehicle 102 to the PADS 104 and the GPS information identifies the location of the vehicle 102.

The processor 202 is also configured to initiate a query or request via the network 106 to one or more of the weather database 108, the transportation database 110, the police database 112, the customer database 114, the map database 116, the manufacturer database 118 and the server computer 120. The respective databases and computers 108-120 retrieve and transmit the requested or queried information back to the network 106. The processor is then configured to receive the requested information via the network 106.

The memory 204 stores the necessary data and programming structures 210 necessary for the operation of the PADS 104. In one embodiment, the memory 204 stores the operating system 206, the PADS interface program 208 and the data structures 210. The memory 204 may comprise a combination of memory devices including random access memory (RAM), nonvolatile or backup memory (e.g., programmable or flash memories, read only memories (ROM), and the like).

The operating system 206 manages the operation of the PADS 106. Namely, the operating system 206 coordinates the receipt signals from and the transmission of signals to the vehicle 102, the databases 110-118 and the server computers 120. The PADS interface program 208 contains instructions for identifying the vehicle 102, retrieving information from various databases and computer servers 108-120 and providing the interface on the PADS 104 or on a display in the vehicle 102. The data structures 210 contain information received from the vehicle 102 and/or information received from one or more types of databases and computers 108-120.

The support circuits 212 include devices that support the operation of the PADS 104. Examples of support circuits 212 include a power supply, a clock, and the like. The input/output interface 214 enables the coordination of the input device 218 and the output device 220 with the vehicle 102. Namely, the input/output interface 214 enables the input device 218 to issue a request to the object tracking devices 104 and the output device 220 to display the inventory of the objects. The network interface 216 enables the PADS 104 to receive and transmit signals with the object tracking devices 104 via the network 112. Examples to the network interface 216 include a transceiver, a modem, a network interface card, and the like.

The input device 218 may comprise any device utilized to provide input to the PADS 104. Examples of the input device 218 include a keypad, a microphone, a touch screen, a light pen, and the like. The output device 220 may comprise any device utilized to provide output for PADS 104. Examples of the output device 220 include a speaker and a display. The output device 220 may operate to display the interface, e.g. driving information and/or advertisements. Although the output device 220 is shown separately from the input device 218, the output device 220 may be combined with the input device 218. The antenna 132 enables the PADS 104 to communicate, i.e., receive and transmit signals, with the vehicle 102 via the wireless network.

FIGS. 3A and 3B collectively depict a flow diagram of a method 300 for implementing the pay at delivery system (PADS) 104. In one embodiment, the method 300 may provide different types of driving information to the driver of the vehicle. For example, the method 300 may provide reminders for service of the detected vehicle 102, provide the fuel efficiency of the vehicle 102, and determine travel routes for the vehicle 102. In other embodiment, the method 300 may provide consumer information, e.g., advertising information, to the driver of the vehicle 102. For example, the method 300 may provide advertisements to the driver of the vehicle 102, provide discounts to future purchases, apply discounts to current purchases, and provide electronic mail messages with information and advertisements.

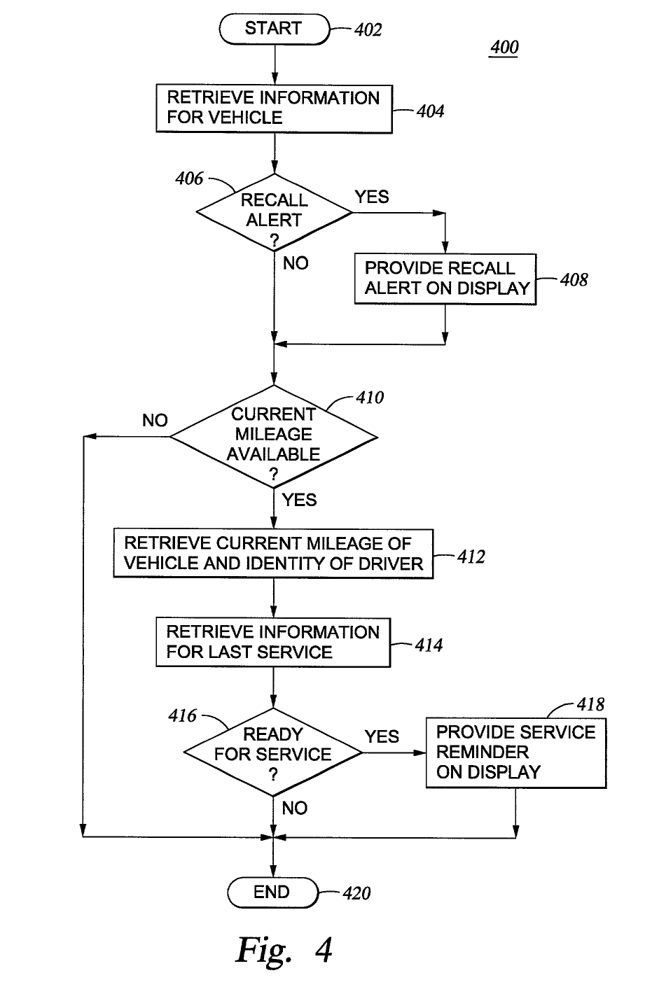

Specifically, the method 300 starts at step 302 and proceeds to step 304 where each detected vehicle 102 is processed. In one embodiment, step 304 detects the RFID code transmitted from the vehicle 102. After detecting the vehicle 102, the method 300 may provide various features of the interface. Although FIG. 3 depicts these features as being implemented in parallel, the features may also be implemented sequentially. The various features in the method 300 are further described with respect to FIGS. 4-9.

At step 306, a query determines whether to provide reminders to the driver of the vehicle 102. If reminders to the driver are to be provided, the method 300 proceeds to step 308 where one or more reminders may be provided to the driver of the vehicle 102. Step 308 is embodied in a method that is further described with respect to FIG. 4. If the reminders to the driver are not to be provided, the method 300 proceeds to detect the next vehicle 102 at step 304.

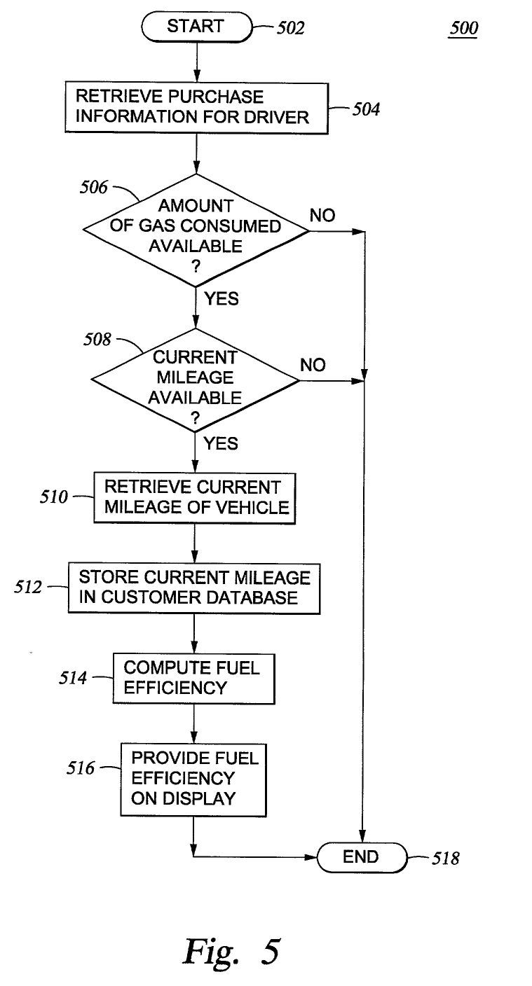

At step 310, a query determines whether to provide a fuel efficiency calculation to the driver of the vehicle 102. If the fuel efficiency calculation is to be provided for the vehicle 102, the method 300 proceeds to step 312 where the fuel efficiency may be provided to the driver of the vehicle 102. Step 312 is embodied in a method that is further described with respect to FIG. 5. If the fuel efficiency is not to be provided for the vehicle 102, the method 300 proceeds to detect the next vehicle 102 at step 304.

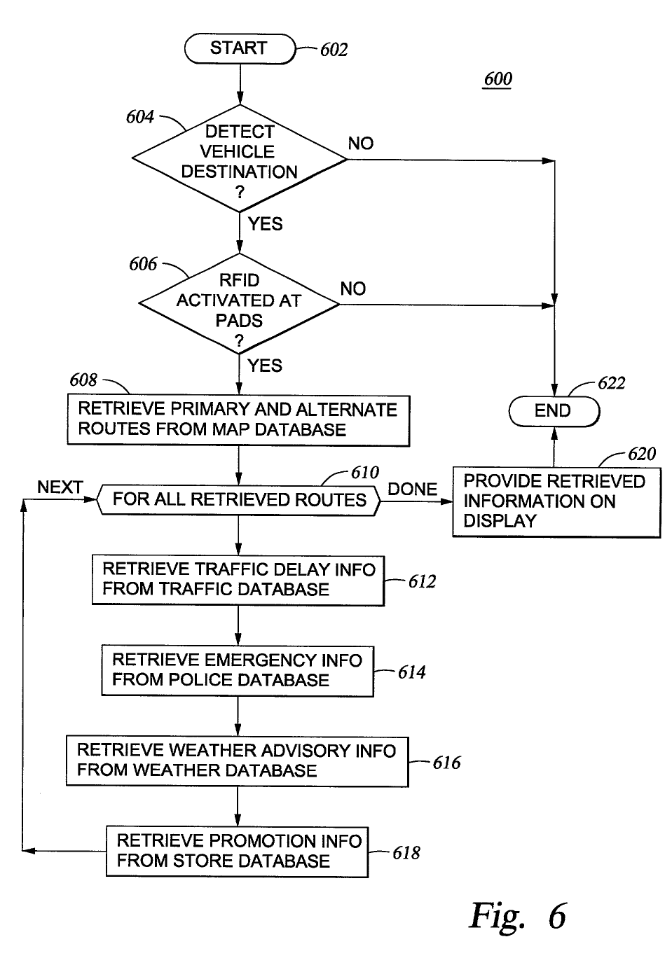

At step 314, a query determines whether to provide travel routes. If travel routes are to be provided, the method 300 proceeds to step 316 where travel routes are determined for the vehicle 102. Step 316 is embodied in a method that is further described with respect to FIG. 6. If the travel routes are not to be provided, the method 300 proceeds to detect the next vehicle 102 at step 304.

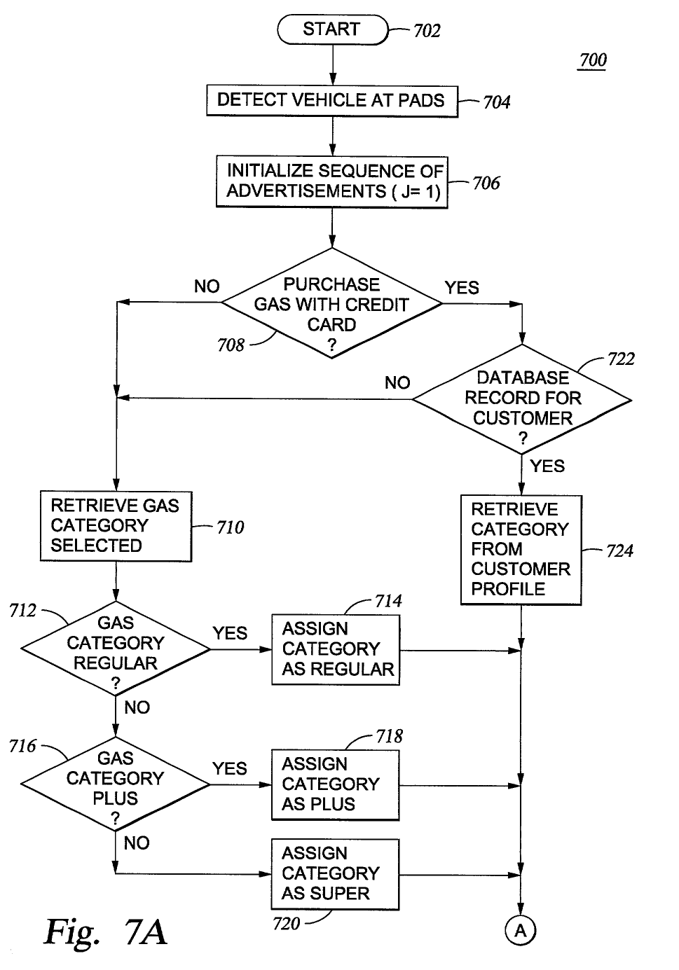

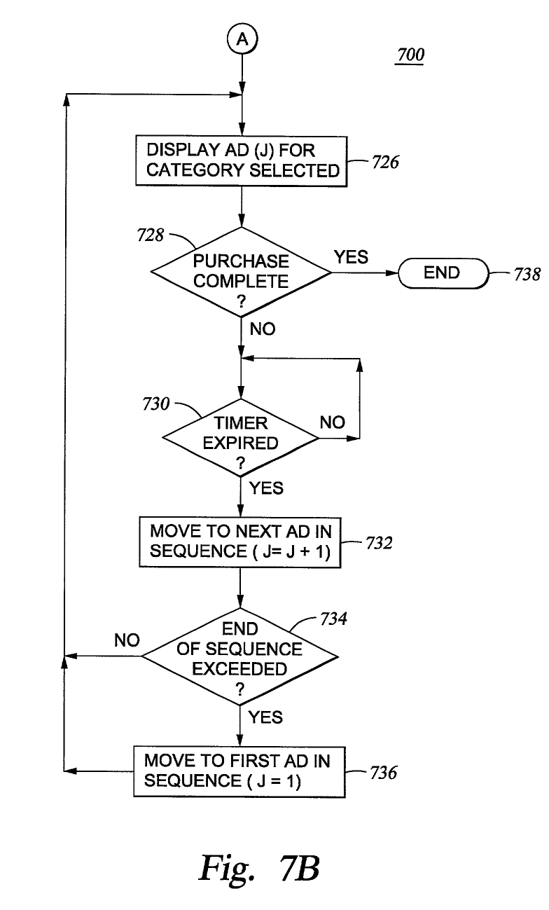

At step 318, a query determines whether to provide advertisements. If advertisements are to be provided, the method 300 proceeds to step 320 where advertisements are provided to the driver of the vehicle 102. Step 320 is embodied in a method that is further described with respect to FIGS. 7A-7B. If advertisements are not to be provided, the method 300 proceeds to detect the next vehicle 102 at step 304.

At step 322, a query determines whether to provide discounts, e.g., credits. If discounts or credits are to be provided, the method 300 proceeds to step 324 where discounts are provided to the driver of the vehicle 102. If discounts or credits are not to be provided, the method 300 proceeds to detect the next vehicle 102 at step 304.

At step 326, a query determines whether to provide electronic mail. If electronic mail is to be provided, the method 300 proceeds to step 328 where electronic mail is provided to the driver of the vehicle 102. If electronic mail is not to be provided, the method 300 proceeds to detect the next vehicle at step 304.

FIG. 4 depicts a flow diagram a method 400 for providing reminders to a driver of the vehicle 102. The method 400 describes one embodiment of step 308. Specifically, the method 400 starts at step 402 and proceeds to step 404 where information for the vehicle 102 is retrieved from the manufacturer database 118. Information for the vehicle may include the model type of the vehicle 102, the year of the vehicle 102, and the like. At step 406, a query determines whether there is a recall alert for the detected vehicle 102. If there is no recall alert for the vehicle 102, the method 400 proceeds to step 410. If there is a recall alert for the vehicle 102, the method 400 retrieves the recall alert from the manufacturer database 118 and provides the alert to the display 220 of the PADS 104 at step 408. Step 408 may also configure the PADS 104 to transmit the alert to the vehicle 102. After providing the recall alert at step 408, the method 400 proceeds to step 410.

At step 410, a query determines whether the current mileage for the vehicle 102 is available. In one embodiment, the current mileage of the vehicle 102 is obtained from the vehicle 102. If the current mileage for the vehicle 102 is not available, the method 400 proceeds to end at step 420. If the current mileage for the vehicle 102 is available, the method 400 proceeds to step 412 where the current mileage of the vehicle 102 and the identity of the driver is retrieved. In one embodiment, the identity of the driver is stored in a customer database 114. The driver may be an “expected” driver of the vehicle 102 that depends upon the time of usage, e.g., father drives the vehicle 102 during the day and the son drives the vehicle during the night. The method 400 proceeds to step 414 where information of the last service of the vehicle 102 is retrieved for the driver of the vehicle 102 from the customer database 114. For example, step 414 may retrieve the mileage of the vehicle 102 when the vehicle 102 was last serviced.

At step 416, a query determines whether the vehicle 102 is ready for service. In one embodiment, step 416 determines whether the difference between the current mileage and the mileage at the last service is greater than a threshold number, e.g., 3000 miles. If the vehicle 102 is not ready for service, the method 400 proceeds to end at step 420. If the vehicle is ready for service, the method 400 proceeds to step 418 where a reminder for service is provided on the display 220 of the PADS 104. Step 418 may also configure the PADS 104 to transmit the reminder to the vehicle 102. After providing the reminder, the method 400 proceeds to end at step 420.

The foregoing examples of reminders are merely illustrative. Persons skilled in the art will readily identify other reminders within the scope of the present invention.

FIG. 5 depicts a flow diagram of a method 500 for providing the fuel efficiency of the vehicle 102. The method 500 provides one embodiment of step 312 introduced above. Specifically, the method 500 starts at step 502 and proceeds to step 504 where the purchase information, e.g., purchase history, for the driver of the vehicle 102 is retrieved from the customer database 114. Such purchase information may include information related to the last gasoline purchase, e.g., the mileage of the vehicle 102 and the level of the gas tank in the vehicle 102.

At step 506, a query determines whether an amount of gas consumed since the last fueling is available. In one embodiment, step 506 may determine whether the gasoline is to be added in the gas tank of the vehicle 102 at the same level of the last gasoline purchase. For example, if the gas tank was filled in the last gasoline purchase, step 506 determines whether the gas tank is going to be filled. In another embodiment, the computer system 122 may track the amount of gas consumed since the last fueling of the vehicle. If the amount of gas consumed since the last fueling is not available, the method 500 proceeds to end at step 518. If the amount of gas consumed since the last fueling is available, the method 500 proceeds to step 508.

At step 508, a query determines whether the current mileage of the vehicle 102 is available. If the current mileage of the vehicle 102 is not available, the method 500 proceeds to end at step 518. If the current mileage of the vehicle 102 is available, the method 500 proceeds to step 510 where the current mileage of the vehicle 102 is retrieved from the vehicle 102. The method 500 proceeds to step 512 where the retrieved mileage is stored in the customer database 114. At step 514, the method 500 computes the fuel efficiency. In one embodiment, step 514 determines the amount of fuel to be filled and calculates the fuel efficiency as the difference between the current and last gasoline purchases divided by the amount of fuel to be filled. The method 500 proceeds to step 516 where the calculated fuel efficiency is provided on the display 220 of the PADS 104. Step 516 may also configure the PADS 104 to transmit the calculated fuel efficiency to the vehicle 102. After step 516, the method 500 ends at step 518.

FIG. 6 depicts a flow diagram of a method 600 for providing available travel routes for a driver of the vehicle 102. The method 600 provides one embodiment of step 314 introduced above. The method 600 may provide different travel routes in view of one or more of the following factors: traffic delay, emergency on roads, weather conditions in an area, and promotions offered by nearby stores. The method 600 starts at step 602 and proceeds to step 604 where a query determines whether a signal containing a destination location is detected from the vehicle 102. In one embodiment, the driver of the vehicle 102 enters the destination location in the computer system 122 within the vehicle 102.

If no GPS destination is detected for the vehicle 102, the method 600 proceeds to end at step 622. If a GPS destination is detected for the vehicle 102, the method 600 proceeds to step 606 where a query determines whether radio frequency identification (RFID) is activated at the PADS 104. If RFID is not activated at the PADS 104, the method 600 proceeds to end at step 622. If RFID is activated at the PADS 104, the method 600 proceeds to step 608 where primary and alternate routes of travel are retrieved from the map database 116.

The method 600 proceeds to step 610 where all the retrieved routes of travel are processed. At step 612, the method 600 retrieves traffic delay information from the transportation database 110. Traffic delay information may include information relating to traffic congestion, road closings, accidents along the route of travel, and the like. The method 600 proceeds to step 614 where emergency information is retrieved from the police database 112. Emergency information may include accidents the along the route of travel, hazardous road conditions, closings due to severe weather, and the like.

The method 600 proceeds to step 616 where weather advisory information is retrieved for the area along the route of travel from the weather database 108. Weather advisory information may include weather forecasts in the area of travel, and effects of severe weather on road conditions. At step 618, the method 600 retrieves promotional information from the server computer 120, e.g., a store database. For example, promotional information may include hotels, stores, and service centers, e.g., gas stations, having other pay at delivery systems (PADS) 104, along the route of travel. These stores and service centers may offer specials on selected purchases or provide certain types of items, e.g., gasoline, food and lodging.

The method 600 proceeds to process the next retrieved route at step 610. Once all the retrieved routes are processed, the method 600 proceeds to step 620 where the retrieved information is provided on the display 220 of the PADS 104. Step 620 may also configure the PADS 104 to transmit the retrieved information for display on the output device 128 of the vehicle 102. In one embodiment, step 620 may provide the optimal or most desirable route for the vehicle 102 given the traffic, weather, road conditions and emergency conditions. Additionally, step 620 may provide a listing of hotels. Such a listing would enable the driver to make a hotel reservation at the PADS 104. After providing the retrieved information, the method 600 proceeds to end at step 622.

FIGS. 7A and 7B collectively depict a flow diagram of a method 700 for providing advertisements for the vehicle 102. The method 700 provides one embodiment of step 318 introduced above. In one embodiment, the method 700 provides “adaptive” advertising based upon the type of gasoline selected by the driver of the vehicle 102. Namely, the method 700 provides a sequence of different advertisements depending on the type of gasoline selected by the driver of the vehicle 102. Specifically, the method 700 may provide a first sequence of advertisements if a “regular” grade of gasoline is selected, a second sequence of advertisements if a “plus” grade of gasoline is selected, and a third sequence of advertisements if a “super” grade of gasoline is selected.

The method 700 starts at step 702 and proceeds to step 704 where the vehicle 102 is detected at the PADS 104. At step 706, a sequence of advertisements is initialized. In one embodiment, the sequence of advertisements is initialized as the first advertisement, i.e., J=1, where J is J-th advertisement in the sequence of advertisements. For example, the first advertisement in the sequence may be the same regardless of the grade of gasoline selected.

The method 700 proceeds to step 708 where a query determines whether the driver, i.e., customer, will purchase gasoline with a credit card. If the gasoline purchase is not to be made with a credit card, the method 700 proceeds to step 710 where the gas category selected at the PADS 104 is retrieved. At step 712, a query determines whether the regular grade of gasoline is selected. If the regular grade of gasoline is selected, the method 700 proceeds to configure a “regular” category of advertisements at step 714 and then to step 726. If the regular grade of gasoline is not selected, the method 700 proceeds to step 716.

At step 716, a query determines whether the plus grade of gasoline is selected. If the plus grade of gasoline is selected, the method 700 proceeds to configure a “plus” category of advertisements at step 718 and then to step 726. If the plus grade of gasoline is not selected, the method 700 proceeds to configure a “super” category of advertisements at step 720 and then to step 726.

Returning to step 708, if the gasoline purchase is to be made with a credit card, the method 700 proceeds to step 722 where a query determines whether a database record or customer profile is available for the customer or driver of the vehicle 102. Namely, step 722 determines whether a database record, e.g., a customer profile, exists for the customer in the customer database 114. In one embodiment, the customer profile contains a default grade of gasoline that is assigned (by the PADS 104) in response to information solicited from the customer. The customer profile may contain a history of the grade or type of gasoline selected by the customer. If no database record is available for the customer, the method 700 proceeds to step 710. If a database record is available for the customer, the method 700 proceeds to step 724 where the category of gasoline normally selected by the customer is retrieved from the customer database 114 and configured for advertisements.

At step 726, the advertisement is displayed for the category of advertisements for the selected grade of gasoline. Namely, step 726 displays AD(J), i.e., the J-th advertisement in the sequence of advertisements, on the PADS 104 for the selected grade of gasoline. The method 700 proceeds to step 728 where a query determines whether the purchase is complete. For example, step 728 may determine whether the service station operator has acknowledged or processed the purchase of gasoline. If the purchase is complete, the method 700 ends at step 738.

If the purchase is not complete, the method 700 proceeds to step 730 where a query determines whether a timer has expired. In one embodiment, the timer represents the amount of time to display an advertisement on the PADS 104. If the timer has not expired, the method 700 returns to step 730. If the timer has expired, the method 700 proceeds to step 732 where the next advertisement in the sequence is processed, e.g., J=J+1.

At step 734, a query determines whether the end of the sequence has been exceeded. If the end of the sequence has not been exceeded, the method 700 returns to step 726 where the next advertisement in the sequence is displayed on the PADS 104. If the end of the sequence has been exceeded, the method 700 proceeds to step 736 where the first advertisement of the sequence is processed. After step 736, the method 700 returns to step 726 where the first advertisement in the sequence is displayed on the PADS 104.

The method 700 represents only one embodiment of providing advertisements to the driver of the vehicle 102. In another embodiment, the method 700 may provide adaptive advertising that is dependent on the weather at the PADS 104. The PADS 104 may use a neural network to determine the type of advertisement as a function of different types of weather. Additionally, the PADS 104 may provide adaptive advertising based upon other factors, e.g., the type of vehicle 102, and a credit report of the driver of the vehicle 102.

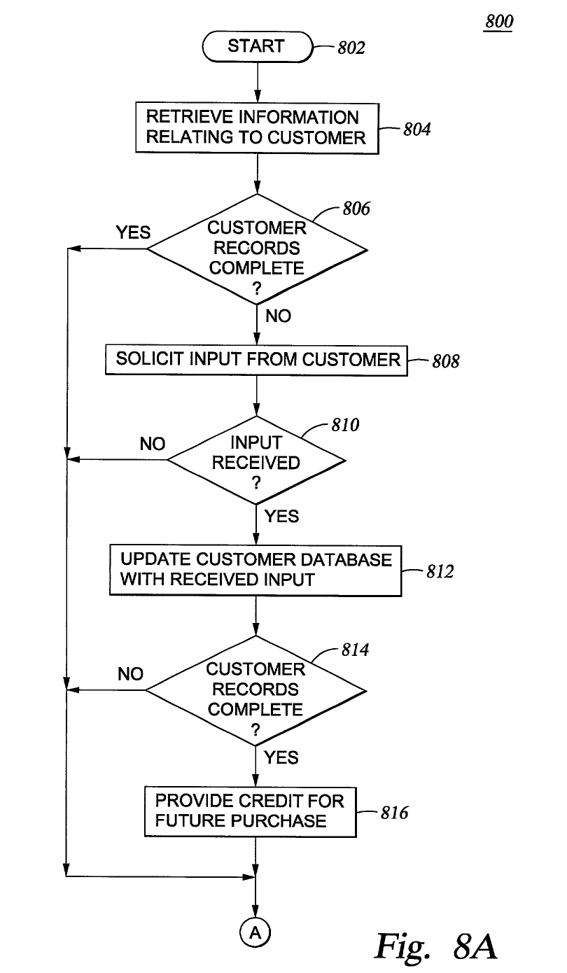

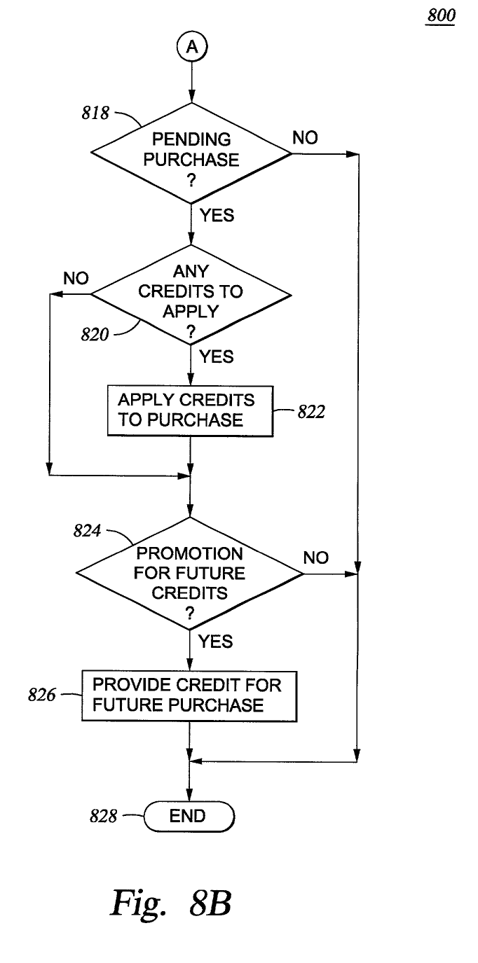

FIGS. 8A and 8B collectively depict a flow diagram of a method 800 for providing and applying discounts. The method 800 provides one embodiment of step 324 introduced above. In one embodiment, the method 800 offers a discount or credit to any customer who provides information that is solicited from the PADS 104. The method 800 starts at step 802 and proceeds to step 804 where information relating to the customer is retrieved from the customer database 114. Such customer information may include the billing address of the driver of the vehicle 102, personal data of the driver, buying preferences of the customer, and status of applicable discounts. The method 800 proceeds to step 806 where a query determines whether the customer records in the customer database 114 is complete. The customer records may include prior purchase information for the customer and information previously submitted from the customer.

If the records are complete for the customer, the method 800 proceeds to step 818. If the records are not complete for the customer, the method 800 proceeds to step 808 where input is solicited from the customer. Step 808 may solicit input at either the vehicle 102 or at the PADS 104. The solicitation of information from the customer enables the PADS 104 to process information on the customer during subsequent visits of the service station, thereby reducing the amount of latency to process the customer during these visits. At step 810, a query determines whether the solicited input has been received. If the solicited input has not been received, the method 800 proceeds to step 818, i.e., no (additional) discount is provided for a future purchase. If the solicited input has been received, the method 800 proceeds to step 812 where the customer database 114 is updated with the received input from the customer.

At step 814, a query determines whether the customer records in the customer database 114 is complete. If the customer records are not complete, the method 800 proceeds to step 818. If the customer records are complete, the method 800 proceeds to step 816 where a discount or credit is applied to a future purchase. In one embodiment, the discount or credit is provided for a specific vehicle identifier for the vehicle 102. A notice of such a discount may be provided for the customer in the customer database 114. After providing the discount at step 818, the method 800 proceeds to step 818.

At step 818, a query determines whether there is a pending purchase. If there is no pending purchase, the method 800 proceeds to end at step 828. If there is a pending purchase, the method 800 proceeds to step 820 where a query determines whether there are any discounts to apply to the pending purchase. If there are no discounts to apply to the pending purchase, the method 800 proceeds to step 824. If there are discounts to apply, the method 800 proceeds to apply the discount at step 822 and then to step 824.

At step 824, a query determines whether to provide a promotion for a future discount. In one embodiment, the promotion may be applied after a purchase. If the promotion for a future discount is not applied, the method 800 proceeds to end at step 828. If the promotion for a future discount is applied, the method 800 proceeds to step 826 where a discount is provided for a future purchase. A notice of this discount may be provided for customer in the customer database 114. After providing the discount at step 826, the method 800 ends at step 828.

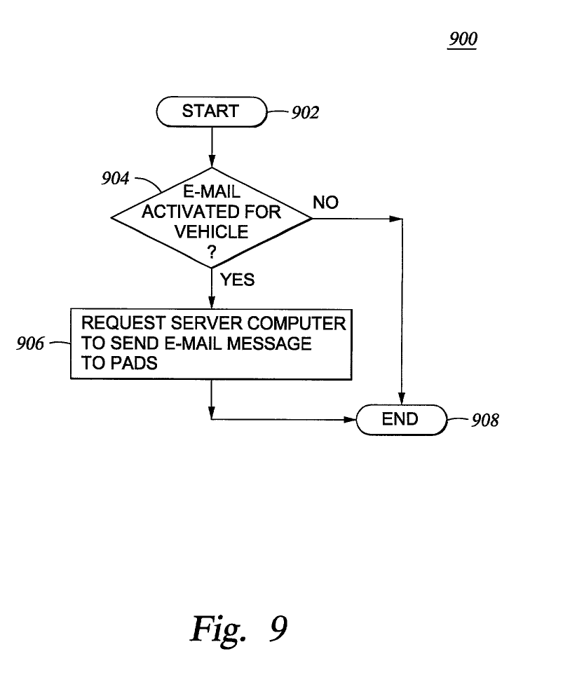

FIG. 9 depicts a flow diagram of a method 900 for providing an electronic mail (e-mail) message to the vehicle 102. The method 900 provides one embodiment of step 328 introduced above. The method 900 starts at step 902 and proceeds to step 904 where a query determines whether electronic mail is activated at the PADS 104 for the vehicle 102. If not, the method 900 ends at step 908. If e-mail is activated for the vehicle 102, the method 900 proceeds to step 906 where a request is provided to the server computer 120, e.g., via the Internet 106. In response to the request, the server computer 120 transmits an e-mail message(s) to the PADS 104. The PADS 104 may display the e-mail message on the display device 220 or enable the transmission of the e-mail message to the vehicle 102. After step 906, the method 900 ends at step 908. Although not shown, it is contemplated that the driver may be required to enter a password, account name, and/or credit card number.

Although various embodiments which incorporate the teachings of the present invention have been shown and described in detail herein, those skilled in the art can readily devise many other varied embodiments that still incorporate these teachings.

What is claimed is:

1. A method of providing an interface to a driver of a vehicle, the method comprising:
receiving a vehicle identifier from the vehicle via a wireless network;
identifying the driver of the vehicle using at least the vehicle identifier; and
providing at least one of driving information and consumer information on a display of a pay-at-delivery system (PADS).

2. The method of claim 1 further comprising:
transmitting at least one of driving information and advertising information to the vehicle via the wireless network, where the driving information and the advertising information is configured for display in the vehicle.

3. The method of claim 1 further comprising broadcasting a signal configured to elicit a transmission of the vehicle identifier from the vehicle.

4. The method of claim 1 wherein the vehicle identifier comprises a radio frequency identifier (RFID) code.

5. The method of claim 1 wherein the providing is performed in response to a transaction between the driver and the PADS.

6. The method of claim 5 wherein the transaction comprises at least one of a receipt of a password from the driver and a receipt of a credit card number from the driver.

7. The method of claim 1 wherein the identifying the driver comprises:
querying a customer database for an identity of the driver of the vehicle given the received vehicle identifier; and
retrieving the identity of the driver from a customer database.

8. The method of claim 1 wherein the driving information comprises at least one of a listing of travel routes to a pay at delivery system (PADS), a vehicle recall alert, a calculation of fuel efficiency for the vehicle, and a service reminder for the vehicle.

9. The method of claim 1 further comprising:
determining whether a recall alert exists for the vehicle; and
transmitting, if the recall alert exists for the vehicle, the recall alert to the vehicle.

10. The method of claim 9 wherein the recall alert is in a manufacturer database.

11. The method of claim 1 further comprising:
obtaining a current mileage of the vehicle;
determining a past mileage of the vehicle when the vehicle was last serviced; and
determining whether a difference between the current mileage and the past mileage of the vehicle is greater than a threshold mileage, where the service reminder is transmitted as driving information if the difference is greater than the threshold mileage.

12. The method of claim 11 wherein the current mileage is transmitted from the vehicle and the past mileage is in a customer database.

13. The method of claim 1 further comprising:
determining whether an amount of gasoline consumed since a last fueling of the vehicle is available;
if so, obtaining a current mileage of the vehicle and the mileage of the vehicle when the vehicle was last fueled; and
calculating a gas mileage of the vehicle from the amount of gasoline consumed, the current mileage of the vehicle and the mileage of the vehicle when the vehicle was last fueled, where the calculated gas mileage is transmitted as driving information.

14. The method of claim 13 wherein the level of gasoline and the mileage of the vehicle when the vehicle was last fueled is in a customer database for the driver of the vehicle.

15. The method of claim 1 further comprising:
obtaining a current location of the vehicle;
determining whether a destination location of the vehicle is obtainable;
retrieving, if the destination of the vehicle is obtained, at least one route from the current location to the destination location; and
retrieving at least one of traffic information, emergency information and weather information for each route, where the traffic information, emergency information and weather information is transmitted as driving information.

16. The method of claim 15 wherein the at least one route is from a map database, the traffic information is from a transportation database, the emergency information is from a police database and the weather information is from a .weather database.

17. The method of claim 1 wherein the consumer information comprises an offer of credit on a future purchase, a sequence of advertisements displayed on a pay at delivery system (PADS), and an electronic mail advertisement message.

18. The method of claim 1 wherein the consumer information comprises advertising information.

19. The method of claim 1 further comprising:
determining a grade of gasoline selected by the driver of the vehicle; and
displaying a sequence of advertisements on a pay at delivery system (PADS) corresponding to the selected grade of gasoline.

20. The method of claim 19 wherein the determining the grade comprises:
identifying a grade of gasoline selected from a purchase history of the driver in a customer database.

21. The method of claim 19 wherein the sequence of advertisements is different for different grades of gasoline.

22. The method of claim 1 further comprising:
determining whether a customer file for the driver is complete in a customer database;
offering, if the customer file in the customer database is incomplete, a credit for a future purchase, where the offering of the credit is transmitted as advertising information; and
providing the credit if the driver completes the customer file.

23. The method of claim 1 further comprising:
determining whether a pay at delivery system (PADS) is activated with a radio frequency identifier (RFID) account; and
requesting a server computer to provide an electronic mail advertisement message to the vehicle, where the electronic mail advertisement message is transmitted to the vehicle as advertisement information.

24. The method of claim 1 wherein the PADS is located at a service station.

25. A method of providing an interface to a driver of a vehicle, the method comprising:
obtaining a current location of the vehicle via a wireless network;
determining whether a destination location of the vehicle is obtainable;
retrieving, if the destination of the vehicle is obtained, at least one route from the current location to the destination location;
retrieving, for each route retrieved, at least one of traffic information, emergency information and weather information; and
providing the retrieved traffic information, emergency information and weather information on a display at a pay-at-delivery system (PADS).

26. The method of claim 25 further comprising:
transmitting the retrieved traffic information, emergency information and weather information to the vehicle via a wireless network.

27. The method of claim 25 wherein the at least one route is from a map database, the traffic information is from a transportation database, the emergency information is from a police database and the weather information is from a weather database.

28. The method of claim 25 wherein the providing is performed in response to a transaction between the driver and the PADS.

29. The method of claim 28 wherein the transaction comprises at least one of a receipt of a password from the driver and a receipt of a credit card number from the driver.

30. The method of claim 28 wherein the transaction comprises a sales transaction.

31. An apparatus for providing an interface to drivers of vehicles, the apparatus comprising:
a memory for storing a pay-at-delivery system (PADS) interface program;
a network interface for communicating with a database;
a wireless communication device for receiving a vehicle identifier from a vehicle;
a display device for displaying at least one of driving information and consumer information; and
a processor, upon executing the PADS interface program, is configured to provide the at least one of driving information and consumer information to the display device.

32. The apparatus of claim 31 wherein the processor is configured to transmit the at least one of driving information and consumer information to the vehicle via the wireless communication device, where the driving information and the advertising information is configured for display in the vehicle.

33. The apparatus of claim 31 wherein the wireless communication device is configured to broadcast a signal configured to elicit a transmission of the vehicle identifier from the vehicle.

34. The apparatus of claim 31 wherein the consumer information comprises a sequence of advertisements dependent upon a grade of gasoline selected by the driver.

35. The apparatus of claim 31 wherein the database comprises one of a weather database, a transportation database, a police database, a customer database, a map database and a manufacturer database.

36. The apparatus of claim 31 wherein the network interface enables communication with a server computer.

37. The apparatus of claim 31 wherein the vehicle identifier comprises a radio frequency identifier (RFID) code.

38. The apparatus of claim 31 wherein the processor is configured to provide the at least one of driving information and consumer information in response to a sale transacted by the driver at the apparatus.

39. The apparatus of claim 31 where the driving information comprises at least one of a listing of travel routes to a PADS, a vehicle recall alert, a calculation of fuel efficiency for the vehicle, and a service reminder for the vehicle.

40. The apparatus of claim 31 wherein the advertising information comprises an offer of credit on a future purchase, a sequence of advertisements displayed on a pay at delivery system (PADS), and an electronic mail advertisement message.

41. The apparatus of claim 31 wherein the processor is configured to take steps to identify the driver using the vehicle identifier.
